(19) United States
(12) Patent Application Publication
(10) Pub. No.: US 2003/0188147 A1
(43) Pub. Date: Oct. 2, 2003

(54) Method for downsizing a computer operating system

(76) Inventor: Shung-Tang Hsu, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/235,341

(22) Filed: Sep. 5, 2002

(30) Foreign Application Priority Data
Apr. 1, 2002 (TW) 91106445

(51) Int. Cl. G06F 15/177

(52) U.S. Cl. 713/1

(57) ABSTRACT

A downsizing method for use in a computer system including software and hardware including a basic input/output system according to the preferred embodiment of the present invention includes a step of executing an operating system consisting of a plurality of files and initialization processes, a step of executing an application, a step of labeling some of the files useful files that are required in the execution of the application and labeling the remaining ones of the files redundant files, a step of providing a downsized version of the operating system via deleting the redundant files, a step of creating a mirror image file of the status of the downsized version of the operating system and of the status of the hardware, and a step of modifying the basic input/output system or the initialization processes so that initialization will be made based on the mirror image file of the downsized version of the operating system.

### BACKGROUND OF INVENTION

1. Field of Invention

The present invention relates to a method for downsizing an operating system for a computer.

2. Related Prior Art

A computer system generally includes a computer and peripherals connected with the computer (or “hardware”) and software for execution in the hardware. An operating system is a type of software specialized in communicating other types of software with the hardware. The other types of software may include applications and system software for example. The operating system interprets commands given by the other types of software into signals that the hardware understands so that the hardware can do things that the software wants it to do. In other words, the operating system must be executed in the hardware so as to take charge of all resources provided by the hardware before the other types of software can be executed in the hardware. In operation of the computer system, a user enters a command or datum in an application that calls the operating system. Then, the operating system instructs the hardware to execute at least one task based on the command or datum.

Other than functioning as an interpreter between the other types of software and the hardware, the operating system is responsible for some tasks of management and scheduling. For example, it may manage who can use the computer and what a certain user can do with the computer.

Furthermore, the operating system is responsible for coordination and arbitration of various applications that compete against each other for the resources. For example, it decides when to assign the CPU to a certain application and when to process a print job of a certain application. Therefore, the operating system takes a key position in a computer system.

Moreover, the operating system provides application programming interfaces: API: a combination of subroutines provided for the applications. A programmer can run the applications to use the API to perform tasks without having to develop the API for making main routines, the applications, run properly in various combinations of hardware. With the API, the programmer can focus on developing applications without having to worry about minor things.

Due to diversity of industries, at the initial stage of the development of the operating system, the programmer has to consider its compatibility with various peripherals and chip sets and to provide necessary device drivers. For example, the latest operating system provided by Microsoft, Windows XP, includes thousands of device drivers in order to upgrade existing computers. This is particularly obvious among computers compatible with PC. Based on this consideration, the operating system often includes a lot of device drivers and initialization processes that may not be necessary for a certain computer. This results in three problems. Firstly, there is a need for a large-volume storage medium. Secondly, the initialization of the computer is complicated and takes a long period of time. Finally, there is a high possibility that the initialization of the computer may fail. Embedded devices and information appliances are particularly vulnerable to these problems.

It is almost for sure that operating systems will include more and more functions and structures such as multimedia, 3D engines and the internet. On the contrary, embedded devices and information appliances are moving towards using a single application and providing just a few functions and using a small-volume storage medium. As for the small-volume storage medium, people prefer a flash memory to a hard disk drive in consideration of reliability. However, a flash memory is far more expensive than a hard disk drive for providing a same volume of storage. As operating systems require larger and larger volumes of storage, they become less and less applicable for embedded devices or information appliances.

There have been two proposals for adapting an operating system to an embedded device and an information appliance.

The first proposal is modularization of an operating system. For example, Windows XP Embedded of Microsoft, Windows NT Embedded of VentureCom and 98Lite of 98Lite.Net are modularized operating systems. Modularization enables experienced engineers to select some of the modules of such a modularized operating system and combine them into a downsized version of the modularized operating system in order to adequately work with a single application. However, some problems have been encountered in this first proposal. Firstly, an engineer must be very familiar with the structure of such a modularized operating system in order to work out a downsized version of the modularized operating system. Secondly, initialization processes still require a large-volume storage medium. Thirdly, such initialization processes can easily be deleted by mistake, thus entailing failure of initialization. Hence, it often takes several days to work out an adequately downsized version of the modularized operating system.

The second proposal is disclosed in U.S. Pat. No. 6,138,271, “Operating System for Embedded Computers” (“'271 patent”). In '271 patent, a modularized operating system is re-designed so that it can scan applications in order to build a list of API and re-compile the source codes thereof in order to select necessary functions only according to the list. However, several problems have been encountered in '271 patent. Firstly, it cannot downsize an operating system via dealing with initialization processes and system resources. In order to be compatible with various peripherals and chip sets, an operating system includes complicated initialization processes. The complicated initialization processes and system resources require a large-volume storage medium. However, '271 patent fails to address such initialization processes. Secondly, it cannot downsize an operating system via addressing other files, such as a device driver database and a device driver cache, that are not necessary for a target application. For instance, Windows XP includes about 14800 files that occupy about 1380 MB. Executable files, dynamic link libraries and device drivers make about one fifth of the files, i.e., 1942 files that occupy about 280 MB. As '271 patent deals only with API and therefore executable files etc., it can at best downsize Windows XP only by one fifth. Thirdly, before applying '271 patent for downsizing an operating system, a user must own its source code and this is impossible when dealing with a commercial operating system such as Windows XP.

The present invention is therefore intended to obviate or at least alleviate the problems encountered in prior art.

### SUMMARY OF INVENTION

It is the primary objective of the present invention to provide a method for downsizing an operating system based on an application so that the application can work properly together with a downsized version of the operating system. Thus, the downsized version of the operating system can be stored in a small-volume storage medium so that it can be used in an embedded device or information appliance.

According to the present invention, a downsizing method for use in a computer system including software and hardware including a basic input/output system according to the preferred embodiment of the present invention includes a step of executing an operating system consisting of a plurality of files and initialization processes, a step of executing an application, a step of labeling some of the files useful files that are required in the execution of the application and labeling the remaining ones of the files redundant files, a step of providing a downsized version of the operating system via deleting the redundant files, a step of creating a mirror image file of the status of the downsized version of the operating system and of the status of the hardware, and a step of modifying the basic input/output system or the initialization processes so that initialization will be made based on the mirror image file of the downsized version of the operating system.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a flow chart of a process for providing a table of resources that an application needs according to the present invention;

FIG. 2 is a flow chart of a process of deleting redundant files and terminating redundant routines according to the present invention;

FIG. 3 is a flow chart of a process of packaging via conducting hibernation in order to create a minimized mirror image file; and

FIG. 4 is a flow chart of a process of modifying a BIOS or initialization processes according to the present invention.

### DETAILED DESCRIPTION OF PREFERRED EMBODIMENT

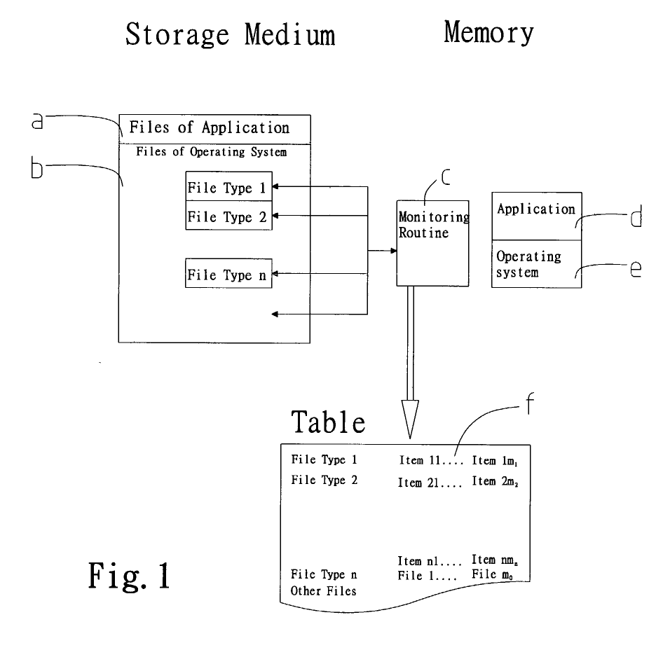

FIGS. 1˜4 show a downsizing method for use in a computer system including software and hardware including a basic input/output system according to the preferred embodiment of the present invention. The downsizing method includes a step of executing an operating system consisting of a plurality of files and initialization processes, a step of executing a target application, a step of labeling some of the files useful files that are required in the execution of the target application and labeling the remaining ones of the files redundant files, a step of providing a downsized version of the operating system via deleting the redundant files, a step of creating a mirror image file of the status of the downsized version of the operating system and of the status of the hardware, and a step of modifying the basic input/output system or the initialization processes so that initialization will be made based on the mirror image file of the downsized version of the operating system.

Referring to FIG. 1, the step of labeling the files will be described. There is provided a monitoring routine or hardware device that can monitor access to a hard disk. Execution of the target application is monitored by means of the monitoring routine/device. Before the target application is executed, the monitoring routine is executed or the monitoring device is operated. The monitoring routine/device monitors and records all resources used by the target application. Some of the files of the operating system that are required in the execution of the target application are labeled useful files, and the remaining ones of the files of the operating system are labeled redundant files. The monitoring routine/device provides a table of the useful files.

During this process, the user must operate the target application comprehensively in order to make sure that the table lists all of the useful files, i.e., the resources required by the target application. The monitoring routine/device must keep track of all necessary resources for running the target application.

Based on knowledge about the operating system, the information to be recorded in the table can be further broken down into subclasses. For example, the monitoring routine/device can monitor usage of individual registry settings in the system registry by the target application and/or usage of API from dynamic link library files. The monitoring routine/device can even monitor and record hard disk sectors used by the target application. A file that can be monitored will be referred to as a “visible file” and its items that can be monitored are named “visible items.” A higher rate of downsizing can be achieved when an operating system includes more visible files. Thus, the monitoring routine/device completely records the access to the visible files and visible items used during the comprehensive operation of the target application.

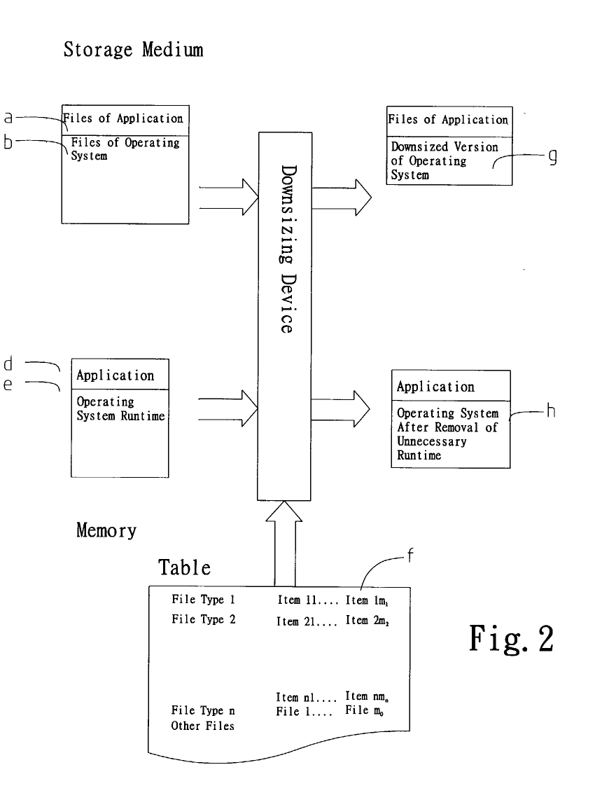

Referring to FIG. 2, the process of providing the downsized version of the operating system will be described. Any file of the operating system that is not listed in the table will be referred to as a “redundant file.” A tool is used to delete the redundant files and redundant items according to the table. Furthermore, this tool terminates redundant routines that are not required to run the target application.

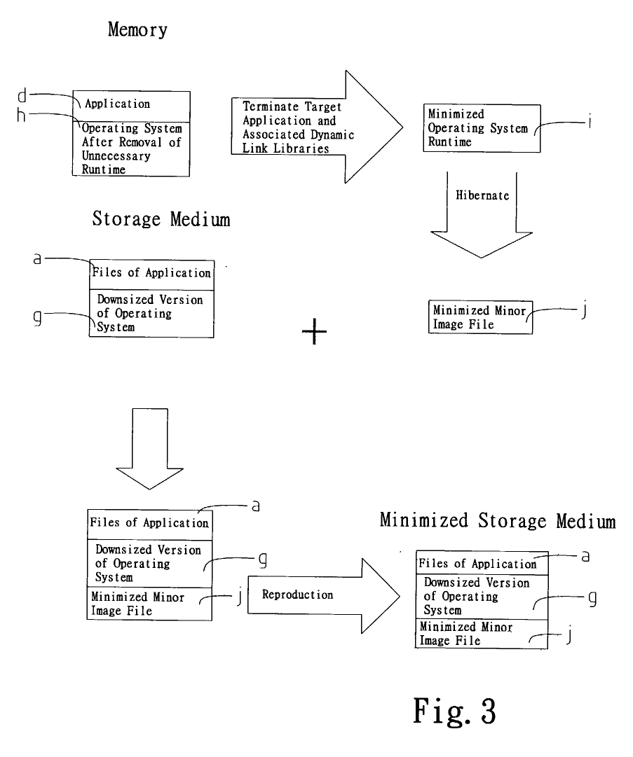

Referring to FIG. 3, the process of packaging via hibernating in order to create a minimized mirror image file will be described. As mentioned, an operating system includes a lot of files designed not to support applications but to detect and initialize various devices and peripherals in system initialization and/or operating system installation. Some of them are used to initialize system modules that are necessary for brining up the operating system and the target application. Normally, these files are not used after the operating system begins to be run and might not be listed by the monitoring routine/device. The tool used in the previous step may delete some of these files and cause the computer system fail to restart.

To solve this problem, the present invention uses a method that is often referred to as “hibernate/resume method” or “suspend/resume” in power management to record in a mirror image file the system status of the running computer system including all chip set registers and system memory contents. In a next boot, the computer system skips the normal complicated initialization process and resumes the previous status with the recorded mirror image file that is kept by the power management system. The hibernate/resume method is controlled by means of the BIOS or the boot loader of the operating system. If the hibernate/resume method is controlled via the boot loader of the operating system, files related to this function cannot be deleted.

A tool is used to terminate the target application in the memory and the dynamic links and resources used by the target application. Then, the hibernate/resume method is used again so as to provide a minimized image file for the usage of the smaller memory. The minimized image file is stored in a main storage medium. At this stage, all the remaining files can be transferred to the smaller memory, most likely a flash disk.

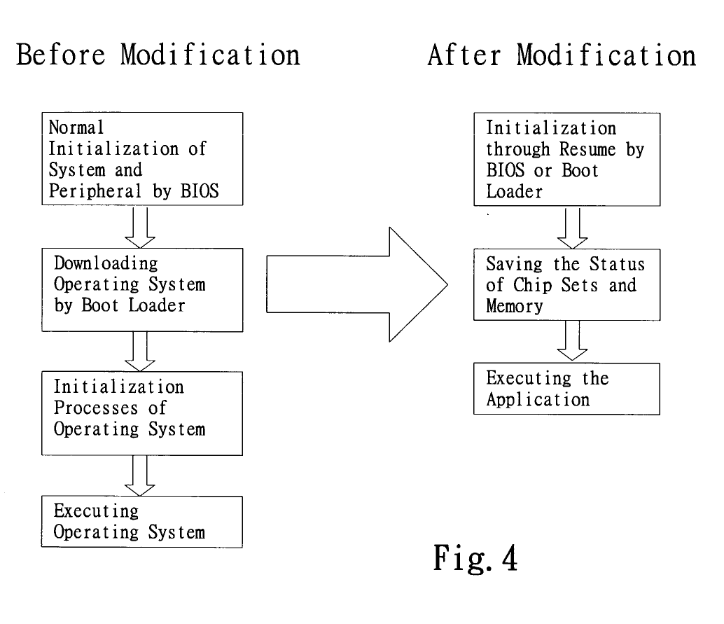

Referring to FIG. 4, the process of modifying a basic input/output system or boot loader will be described. The BIOS or boot loader of the computer system is modified to always resume the minimized mirror image file provided as a result of the previous process. Moreover, it launches the target application after the system resumes the previous steps with the hibernation/resume method from the power management system.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A downsizing method for use in a computer system including software and hardware including a basic input/output system, the downsizing method including the steps of:
executing an operating system consisting of a plurality of files and initialization processes;
executing a target application;
labeling some of the files useful files that are required in the execution of the application and labeling the remaining ones of the files redundant files;
providing a downsized version of the operating system via deleting the redundant files;
creating a mirror image file of the status of the downsized version of the operating system and of the status of the hardware; and
modifying one of the basic input/output system and the initialization processes so that initialization will be made based on the mirror image file of the downsized version of the operating system.

2. The downsizing method according to claim 1 wherein the step of labeling the files includes a step of comprehensively executing the target application.

3. The downsizing method according to claim 2 wherein the step of labeling the files includes a step of monitoring access to the files during the comprehensive execution of the target application.

4. The downsizing method according to claim 3 wherein the step of monitoring the access to the files includes a step of providing one of a monitoring routine and a monitoring device.

5. The downsizing method according to claim 4 wherein the step of labeling the files includes a step of providing a table of the useful files after the step of monitoring the files.

6. The downsizing method according to claim 5 wherein each of the useful files includes at least one item, and the step of providing the table includes a step of labeling any of the items required in the execution of the target application a useful item and any of the items not required in the execution of the target application a redundant item.

7. The downsizing method according to claim 6 wherein the useful items include an item related to a disk sector to which access is made.

8. The downsizing method according to claim 5 wherein the step of providing the table of the files includes a step of saving the table in a storage medium.

9. The method according to claim 8 wherein the storage medium is a compact disk.

10. The method according to claim 8 wherein the storage medium is a magnetic disk.

11. The method according to claim 8 wherein the storage medium is a magnetic tape.

12. The method according to claim 8 wherein the storage medium is a flash memory.

13. The method according to claim 1 wherein the step of creating the mirror image file is taken via a hibernate/resume method process.

14. The method according to claim 1 including a step of saving the downsized version of the operating system in a storage medium.

15. The downsizing method according to claim 1 wherein the step of modifying one of the basic input/output system and the initialization processes includes a step of modifying the initialization processes.

16. The downsizing method according to claim 15 wherein the initialization processes include a boot loader, and the step of modifying the initialization processes includes a step of modifying the boot loader.
